(19) United States
(12) Patent Application Publication
(10) Pub. No.: US 2003/0094769 A1
(43) Pub. Date: May 22, 2003

(54) Sealing screw

(76) Inventor: Peter Tyroller, Ochsenfeld (DE)

Correspondence Address: MUSERLIAN AND LUCAS AND MERCANTI, LLP, 600 THIRD AVENUE, NEW YORK, NY, 10016, US

(21) Appl. No.: 10/288,690

(22) Filed: Nov. 5, 2002

(30) Foreign Application Priority Data
Nov. 16, 2001 (DE) 101 56 507.0

(51) Int. Cl. F16J 15/08

(52) U.S. Cl. 277/608; 277/627

(57) ABSTRACT

A sealing screw (1) comprising a head (4) and a shank (3) comprises on the underside of the head (4), an annular groove (5) having an undercut into which a metallic sealing ring (6) is pressed with a portion of its axial thickness “a”.

### FIELD OF THE INVENTION

The invention concerns a sealing screw for sealingly closing a bore having an internal thread, said sealing screw comprising a head and a shank having an external thread, an underside of the head comprising an annular groove having an undercut, a sealing ring being arranged in the annular groove, so that with help of the external thread of the shank, the head can be moved toward the bore, with the underside foremost, till the sealing surface of the sealing ring comes to bear against the bore.

### BACKGROUND OF THE INVENTION

A sealing screw of the pre-cited type for sealingly closing a housing is known from DE 86 14 676.9 U1. This screw comprises an externally threaded shank and a screw head comprising on an underside, an annular groove and an undercut. When the shank of this screw is screwed into an internally threaded bore that has to be sealed, a plastic ring inserted into the annular groove comes to bear against the bore and sealingly closes the same.

A drawback of this prior art is that the annular groove is axially recessed, i.e. it is open toward the outside in direction of the shank. However, such an axial recess is very expensive and complicated to make. A further drawback is that plastic rings do not meet the requirements of all cases of use. For example, they are often not suitable for use in the construction of engines. Finally, a further drawback of this particular prior art is that a very precise insertion of the plastic ring into the groove is required so that automation of the manufacturing procedure as a whole is problematic.

### OBJECTS OF THE INVENTION

It is an object of the invention to provide a sealing screw that is suitable for all cases of use and is economic to manufacture while having a carefully configured sealing surface.

This and other objects and advantages of the invention will become obvious from the following detailed description.

### SUMMARY OF THE INVENTION

The invention achieves the above objects by the fact that the annular groove is open outwardly in radial direction, the sealing ring is made of a metallic material and is pressed into a region of the undercut of the annular groove by a deforming force that is applied to a portion of an axial thickness of the sealing ring.

One advantage of the invention is that the annular groove can be made in a very simple manner with all common automatic turning lathes by radial recessing, so that its manufacturing is particularly economic. A further advantage is that the sealing screw and the sealing ring form an inseparable assembly, and the reshaping of the metal sealing ring is unproblematic. Another advantage, finally, is that due to a flat contact of the sealing ring both with the head of the sealing screw and with the aperture to be sealed, a good sealing effect is obtained, while, at the same time, the actual sealing surface remains fully usable, i.e. no part of the sealing surface is lost due to the shaping process.

According to a particularly advantageous proposition of the invention, the sealing ring is made of steel, aluminium, copper or brass, the choice of the material depending on the particular intended use. All the mentioned materials can be plastically deformed in a simple manner.

According to a further feature of the invention, the sealing ring is pressed with half its thickness into the region of the undercut. This measure assures on the one hand, that the sealing ring is inseparably retained on the sealing screw, and on the other hand, the entire sealing surface remains usable.

According to further features of the invention, the sealing ring may be arranged in the annular groove for free rotation or be firmly fixed therein.

Finally, in a further proposition of the invention, the sealing screw is used for sealing an opening in a housing of a hydraulic tensioner for a chain or a belt drive in which a hollow cylindrical element is inserted into a reception aperture arranged in the shank, and a spring-loaded piston is guided for longitudinal displacement in a bore of the hollow cylindrical element to press against a chain or a belt through a tensioning arm.

The invention will now be described more closely with reference to an example of embodiment illustrated in the appended drawings.

### BRIEF DESCRIPTION OF THE DRAWINGS

FIG. 1 is a longitudinal section through a sealing ring,

FIG. 2 is a top view of the sealing ring of FIG. 1,

FIG. 3 is a longitudinal section through a sealing screw having a sealing ring placed thereon,

FIG. 4 is a longitudinal section through a sealing screw with a pressed-in sealing ring,

FIG. 5 is an enlarged representation of a detail of FIG. 4,

FIG. 6 is a longitudinal section through a forming tool,

FIG. 7 is a longitudinal section through a forming tool with a sealing screw received therein,

FIG. 8 is an end view of a camshaft drive having a chain tensioner, and

FIG. 9 is a longitudinal section through a sealing screw having a tensioner.

### DETAILED DESCRIPTION OF THE DRAWINGS

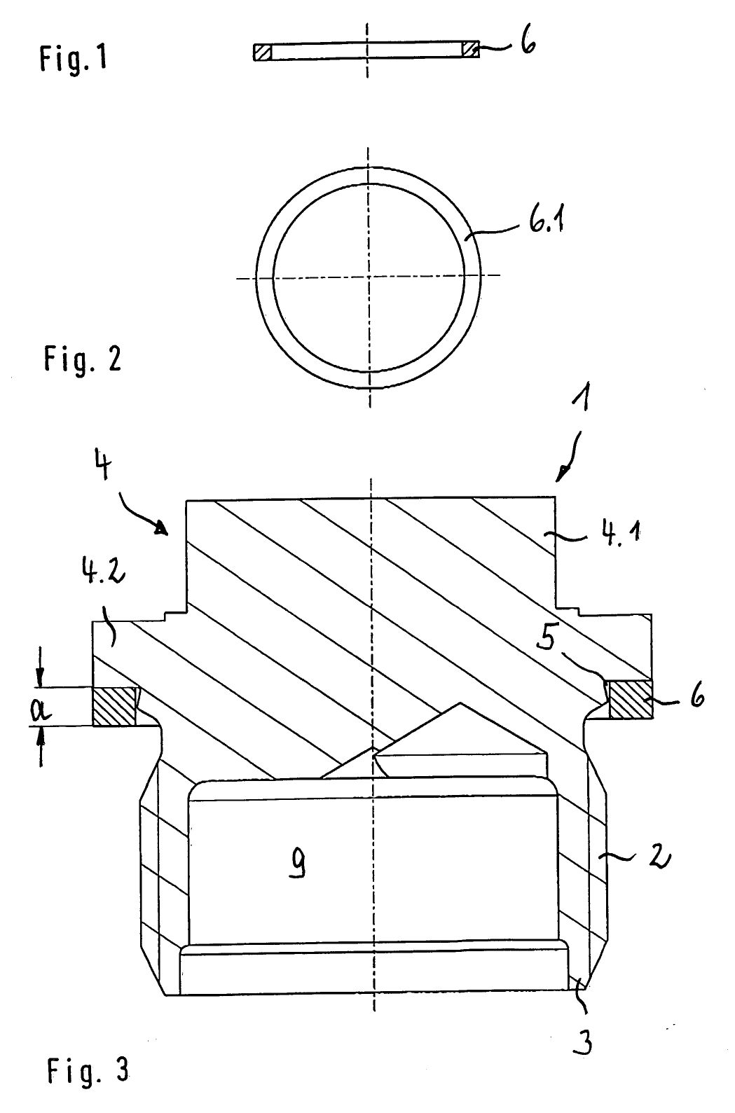

According to FIGS. 1 to 5, the sealing screw 1 comprises a shank 3 having an external thread 2 and a head 4 that is made up in the present example embodiment of the invention, of an upper head section 4.1 and a lower head section 4.2. As seen in a top view, the upper head section 4.1 has a polygonal shape and the lower head section 4.2 as seen in a top view, has a circular shape. The shank 3 further comprises in its interior, a reception bore 9 that creates a reception space for components.

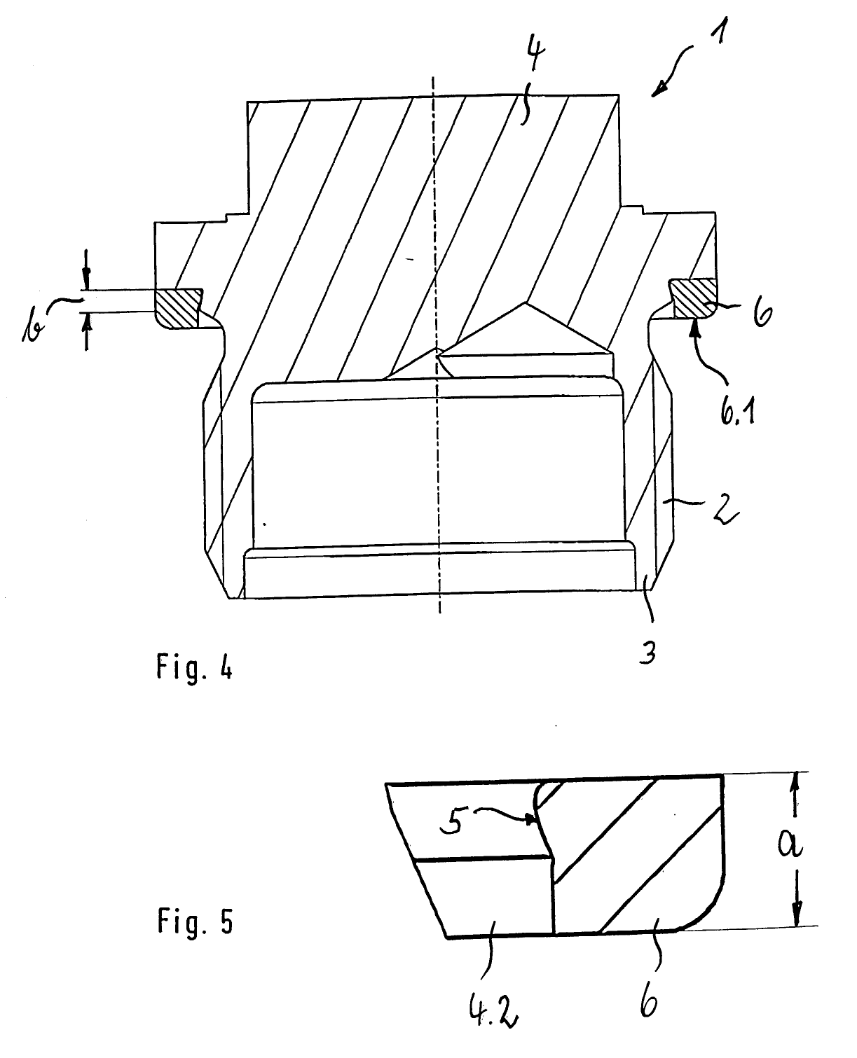

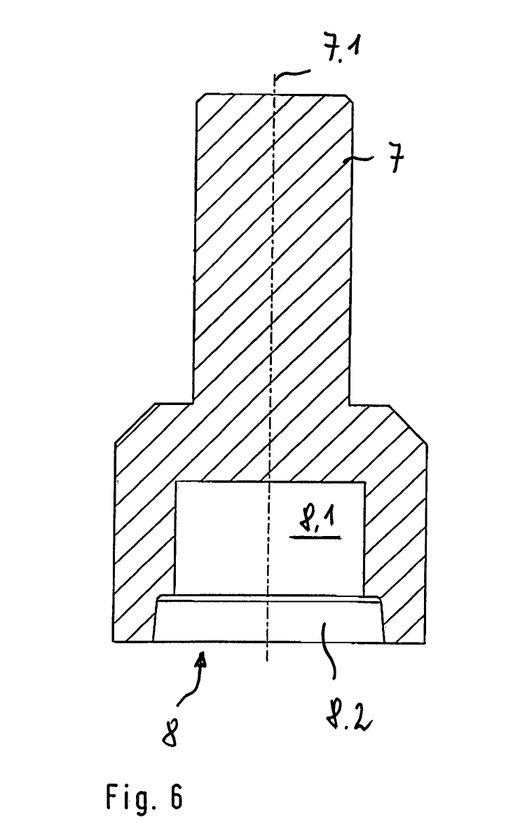

As further shown in the aforesaid figures, the underside of the lower head section 4.2 comprises an annular groove 5 having an undercut. According to the invention, this annular groove 5 is open outwardly in radial direction. As best seen in FIG. 3, the metal sealing ring 6 is slipped onto the annular groove 5 and is then pressed, as can be seen in FIGS. 4 and 5, by mechanical shaping into the undercut of the annular groove 5. It is further discernible that the sealing ring 6 has an axial thickness ‘a’ that is approximately twice as large as the axial depth ‘b’ of the annular groove 5. In this way, it is assured that only a part of the axial thickness of the sealing ring 6 is pressed into the annular groove 5, so that the sealing surface 6.1 of the sealing ring 6 oriented toward the opening to be sealed is not diminished by the pressing-in.

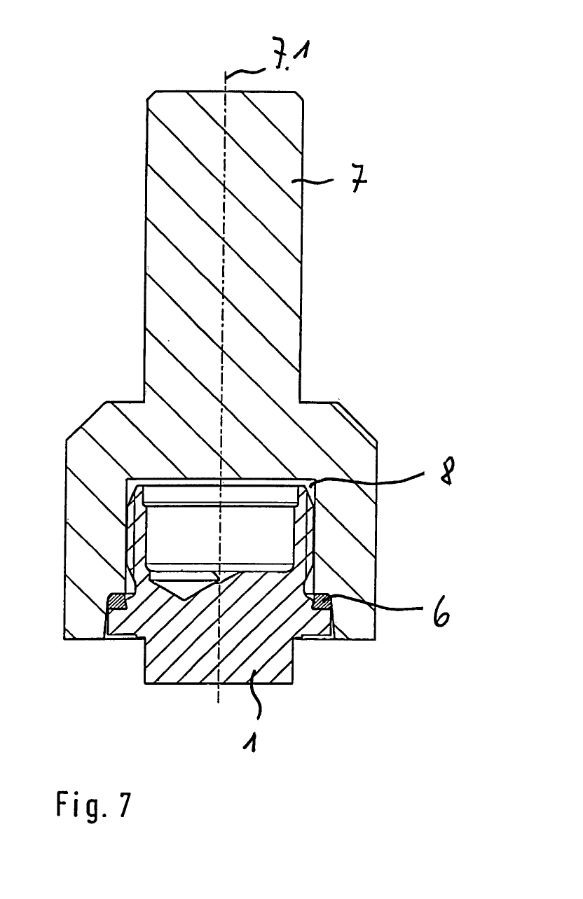

FIGS. 6 and 7 show the tool 7 required for pressing in the metal sealing ring 6. This tool comprises a stepped reception aperture 8 into which the sealing screw 1 including the sealing ring 6 placed thereon is inserted. The reception aperture 8 comprises a circular upper part 8.1 that has a rectangular shape when seen longitudinal section, and a circular lower part 8.2 that has a trapezoidal shape when seen in longitudinal section. As shown in FIG. 7, the tool 7 is moved in direction of its axis 7.1 against the sealing surface 6.1 of the sealing ring 6, so that half the thickness of the sealing ring 6 is pressed into the undercut of the annular groove 5.

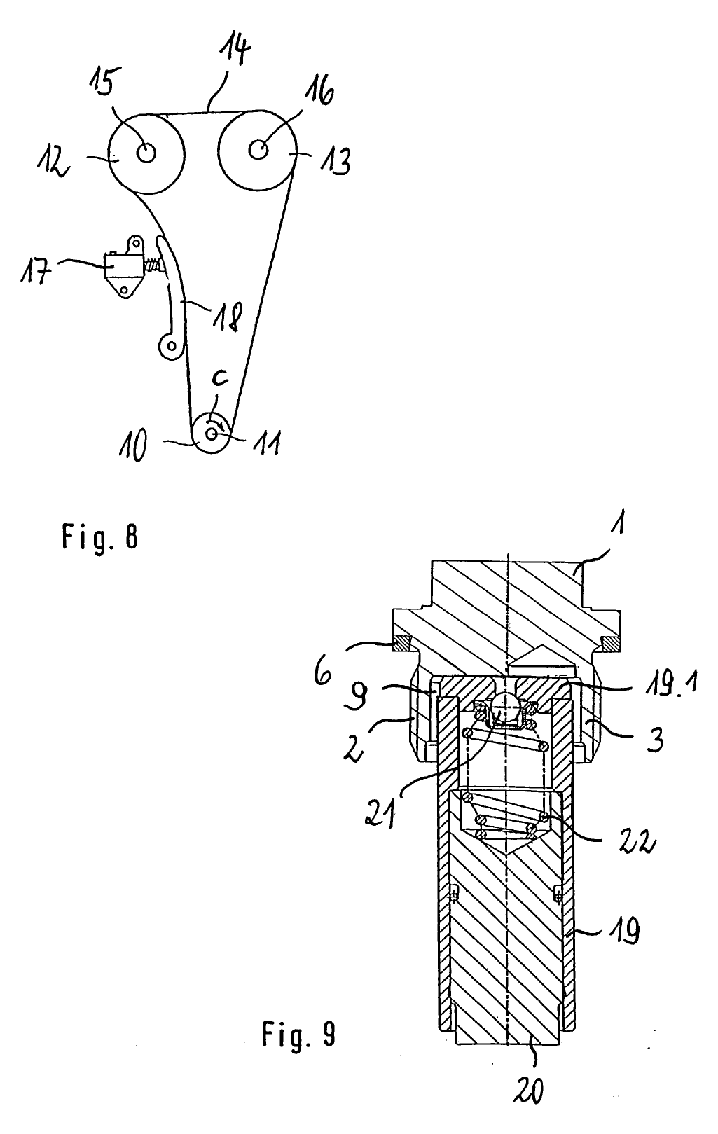

The camshaft drive shown in FIG. 8 comprises a drive sprocket wheel 10 that is fixed on a crankshaft 11 and drives sprocket wheels 12, 13 through a timing chain 14, the sprocket wheels 12, 13 being fixed on camshafts 15, 16. The arrow “c” shows the direction of rotation of the crankshaft 11. A hydraulic chain tensioner 17 is arranged on the slack part of the chain 14 and exerts a tensioning force on the chain 14 through a tensioning arm 18.

The sealing screw 11 of the invention including the sealing ring 6 shown in FIG. 9 can be advantageously used in the hydraulic tensioner 17 represented in FIG. 8. Inserted into the reception aperture 9 of the shank 3 is a hollow cylindrical element 19 in whose bore a piston 20 is guided for longitudinal displacement. A bottom 19.1 of the hollow cylindrical element 19 comprises a one-way valve 21. A coil compression spring 22 is supported on the bottom 19.1 and acts on the piston 20 so as to bias it in outward direction and thus tighten the chain 14 through a tensioning arm 18 shown in FIG. 8.

Further details of the mode of functioning of a hydraulic tensioner are not required here because they do not form an essential part of the invention. Moreover, they are sufficiently known to the person skilled in the art from numerous prior art documents. A hydraulic tensioner of the type concerned for use in a chain drive is described, for instance, in the document DE 196 31 607 A1.

What is claimed is:

1. A sealing screw for sealingly closing a bore having an internal thread, said sealing screw comprising a head and a shank having an external thread, an underside of the head comprising an annular groove having an undercut, a sealing ring being arranged in the annular groove, so that with help of the external thread of the shank, the head can be moved toward the bore, with the underside foremost, till the sealing surface of the sealing ring comes to bear against the bore, wherein the annular groove is open outwardly in radial direction, the sealing ring is made of a metallic material and is pressed into a region of the undercut of the annular groove by a deforming force that is applied to a portion of an axial thickness of the sealing ring.

2. A sealing screw of claim 1, wherein the metallic material of which the sealing ring is made is chosen from the group consisting of steel, aluminium, copper and brass.

3. A sealing screw of claim 1, wherein the sealing ring is pressed with half the axial thickness into a region of the undercut.

4. A sealing screw of claim 1, wherein the sealing ring is arranged for free rotation in the annular groove.

5. A sealing screw of claim 1, wherein the sealing ring is firmly fixed in the annular groove.

6. A sealing screw of claim 1 used for sealing an opening in a housing of a hydraulic tensioner for a chain drive in which a hollow cylindrical element is inserted into a reception aperture arranged in the shank, and a spring-loaded piston is guided for longitudinal displacement in a bore of the hollow cylindrical element to press against a chain through a tensioning arm.

7. A sealing screw of claim 1 used for sealing an opening in a housing of a hydraulic tensioner for a belt drive in which a hollow cylindrical element is inserted into a reception aperture arranged in the shank, and a spring-loaded piston is guided for longitudinal displacement in a bore of the hollow cylindrical element to press against a belt through a tensioning arm.
